(19) United States
(12) Patent Application Publication
(10) Pub. No.: US 2001/0042096 A1
(43) Pub. Date: Nov. 15, 2001

(54) Satellite communication conference system and conference method capable of real-time conference

(76) Inventor: Osamu Ichiyoshi, Tokyo (JP)

Correspondence Address: McGuire Woods, Suite 1800, 1750 Tysons Boulevard, Tysons Corner, McLean, VA, 22102-3915, US

(21) Appl. No.: 09/851,976

(22) Filed: May 10, 2001

(30) Foreign Application Priority Data
May 12, 2000 (JP) 140669/2000

(51) Int. Cl. G06F 15/16; G06F 15/173

(52) U.S. Cl. 709/204; 709/239

(57) ABSTRACT

A content of a comment of a speaker participating in a conference is broadcasted, via a communication satellite, to a participant having a satellite communication terminal including a receiving unit for receiving a signal from the communication satellites. A conference center which is connected to a satellite earth station for satellite communication with the communication satellite includes a back-way communicating unit for accepting a voice request signal of the participant in the conference and a comment signal of the participant to whom a voice is granted, and ground communicates data via a ground communication network for the participant having a satellite communication terminal without a transmitting unit to the communication satellite.

### BACKGROUND OF THE INVENTION

1. Field of the Invention

The present invention relates to a satellite communication conference system, and more particularly, to a satellite communication conference system and a conference method for an effective and safe conference among a numerous number of participants by using satellite communication characteristic of wide coverage, broadcasting, and broad band.

2. Description of the Related Art

In recent yeas, a conference system for conference through an electronic bulletin board using the Internet has been generally employed Also, a remote conference system using the satellite communication has been widely employed.

FIG. 1 shows an example of the configuration of a conventional conference system using the Internet (Internet conference system). Referring to FIG. 1, an electronic bulletin board is set on a homepage 8. Operation of the Internet conference system is as follows.

(1) A chairperson 6 corresponds to a terminal of a data creator, and draws up an agenda of a conference and bulletins it on the electronic bulletin board of the homepage 8.

(2) One subscriber 9 to participate in the conference corresponds to a terminal capable of accessing the Internet. The subscriber 9 accesses the homepage 8 via an Internet (ground communication network) 7, reads out the conference agenda bulletined on the electronic bulletin board, and if he/she wants to add a comment on the agenda, he/she writes it to the electronic bulletin board

(3) Another subscriber 9 also accesses the homepage 8, reads out the conference agenda and the comment bulletined on the electronic bulletin board, and if he/she wants to add a comment on the agenda, he/she writes it to the electronic bulletin board. The conference is performed as mentioned above.

(4) The chairperson 6 facilitates discussion on the electronic bulletin board in the case of inputs from the subscribers 9.

As described above, the participant in the conference can input and read out the comment at his/her convenient time. So long as the participant can access the Internet, he/she can the input and reading operation anywhere. In other words, there is no restriction of place for the participant in the conference.

The use of the Internet enables freedom from time and space constraints and simple constitution of an interactive conference system on bidirectional communication with high degree of freedom. The variety of information based on formats of not only a character but also of a picture, image, sound, or the like, can be used for a subject Indeed, the Internet conference system can be a breakthrough conference system.

However, the aforementioned Internet conference system has the following problems.

A first problem is that real-time conference is impracticable. The reasons are as described below.

The Internet conference system has a feature that data are stored in a main homepage and a user reads out the stored data via a communication line as needs arise. The real-time conference necessitates the setting of the communication line to all subscribers 9 from the homepage 8. As the number of subscribers increases, the setting of the communication line becomes extremely difficult.

The above description is just applicable to the Internet based on packet communication, and multi-cast systems are actively researched However, under the present situation, practical solution is difficult.

As mentioned above, the conventional Internet conference system has a problem that the real-time conference is impracticable.

A process for writing the comment to the electronic bulletin board presented by an Internet service provider (ISP) by one participant and a process for accessing the electronic bulletin board and reading out the comment by another participant are performed at different times. If the number of participants is increased, the access to the single electronic bulletin board is congested and then the response is excessively slow, thus substantially making operation for the Internet conference system impossible.

A second problem is that communication costs rise.

Originally, the Internet is a system for connecting points based on a packet communication system, and the communication cost per subscriber is not reduced if the number of subscribers is increased. If the line is busy, the number of delay times rises, thus causing the implementation of the conference to be hard. In addition, if the conference is prolonged, the communication costs rise in the case of a time account system.

As one system for implementing the real-time conference, a method for communication using a satellite communication terminal capable of reception and transmission is known. In Japan, this system is employed for an autonomy VSAT (Very Small Aperture Terminal) system and a VSAT system between universities

However, in the conventional conference system using the satellite communication terminal, units therein have large size and are expensive. Also, in this conference system, access fees of the satellite communication system are expensive Except for application for business use, it is unavailable for general purpose use A conventional conference system using the satellite communication system, as an example, adopts a moving picture system for transmitting a television signal, and the satellite communication is employed in both a broadcasting channel as a fore-way line and a comment channel as a back-way line. Therefore, the system is remarkably expensive and, in general, is not so widespread, excluding only government, university and one part of large corporations which adopt the system.

### SUMMARY OF THE INVENTION

Accordingly, it is one object of the present invention to provide a satellite communication conference system capable of safely implementing a conference among a large number of participants with low costs based on a real-time manner

It is another object of the present invention to provide a conference method preferable to the application to a business model for providing a satellite communication conference with low costs based on the real-time manner in which a mass subscribers participate.

Other objects, features, advantages, and the like of the present invention will be apparently understood by persons skilled in the art.

According to the present invention, there is provided a satellite communication conference system using satellite communication wherein a content of a comment of a speaker participating in a conference is broadcasted, via a communication satellite, to a plurality of conference participants having satellite communication terminals including receiving units for receiving a signal from the communication satellite.

Further, according to the present invention, there is provided a satellite communication conference system carrying out conference via a communication satellite and comprising a receiving and transmitting terminal having a receiving and transmitting function from/to the communication satellite, a receiving terminal having only a receiving function to the communication satellite, a satellite earth station for communication via the communication satellite, and a conference center which is connected to the satellite earth station. A satellite communication network connects the conference center and the receiving and transmitting terminal. A ground communication network connects the conference center and the receiving terminal. According to an aspect of the present invention, in the satellite communication conference system, particularly, the content of the comment of the speaker participating in the conference is broadcasted to the participant having the receiving and transmitting terminal and the participant having the receiving terminal via the communication satellite. In addition, the conference center has a unit for receiving a voice request signal of the participant and a comment signal from the participant to whom a voice is granted via the ground communication network for the participant having the receiving terminal.

Further, according to the present invention, there is provided a satellite communication conference method using satellite communication. In the present conference method, a content of a comment of a speaker participating in a conference is broadcasted, via the communication satellite, to a plurality of conference participants having terminals comprising functions for reception signals from a communication satellite.

Furthermore, according to the present invention, there is provided a business model for presenting a satellite communication conference service in a satellite communication conference system. The satellite communication conference system comprises a receiving and transmitting terminal having a receiving and transmitting function from/to a communication satellite, a receiving terminal having only a receiving function to the communication satellite, a satellite earth station for communication via the communication satellite, and a conference center which is connected to the satellite earth station. A satellite communication network connects the conference center and the receiving and transmitting terminal, and a ground communication network connects the conference center and the receiving terminal In the present business model, the content of the comment of the speaker participating in the conference is broadcasted, via the communication satellite, to a participant having the receiving and transmitting terminal and a participant having the receiving terminal. In addition, the conference center has a unit for receiving a voice request signal from the participant in the conference and a comment signal from the participant to whom a voice is granted via the ground communication network for the participant having the receiving terminal.

### BRIEF DESCRIPTION OF THE DRAWINGS

FIG. 1 is a diagram of the configuration of a conventional conference system using the Internet;

FIG. 2 is a diagram showing the configuration of a satellite communication conference system according to an embodiment of the present invention;

FIG. 3 is a diagram showing the configuration of a subscriber terminal of the present invention, shared with a satellite broadcast receiving unit;

FIG. 4 is a diagram showing the configuration of a bidirectional satellite communication terminal shared with a VSAT terminal as the subscriber terminal in the embodiment of the present invention; and

FIG. 5 is a diagram showing the configuration of a satellite earth station and a conference center according to the embodiment of the present invention.

### DESCRIPTION OF THE PREFERRED EMBODIMENT

A description is given of components constituting a satellite communication conference system of the present invention hereinbelow.

The satellite communication conference system of the present invention is performed via a communication satellite and a satellite communication network or ground communication network which connects a conference center and subscriber terminals. The satellite communication conference system includes the subscriber terminals capable of receiving a signal from the communication satellite, a satellite earth station for main communication via the communication satellite, and the conference center which is set at the same place as the satellite earth station or is connected via a communication line.

[Satellite communication]

In the satellite communication using a stationary satellite, a single satellite can simultaneously provide a communication network throughout a wide area corresponding to ⅓ of the ground surface. A feature of a fore-line communication in the satellite communication is broadcasting as well as wide coverage. In particular, the satellite communication is suitable to broadcast and is currently used on business as a direct satellite broadcast.

Recently, an antenna having a large aperture is mounted on the communication satellite and output power is exceedingly increased, thereby enabling the communication with a large capacity. Also, receiving sensitivity of the communication satellite is remarkably improved, thereby enabling fast communication from a small satellite communication terminal that a subscriber has. As a consequence, as the feature of the satellite communication, in addition to the wide coverage and broadcasting, a wide band is enhanced and, thus, the performance is exceedingly improved as a communication network.

[Problem of the Internet]

Recently, the rapid growth of the Internet and business using the Internet becomes remarkable. In accordance therewith, obviously, the current Internet exhibits disadvantages. For example, real-time communication is infeasible among a numerous number of participants on the current Internet. Although the Internet is most proper to communicate a small amount of data among any desired points, it is improper to communicate a large number of data among many points. Various multi-cast systems are researched and, however, the impracticality Is caused by the structure itself of an Internet communication network and, fundamentally, the solution is hard.

On the contrary, the above-mentioned direct satellite broadcast (DSB) is most widely spread and applied as the satellite communication, Only in Japan, several million subscribers use TV and radio broadcasts of several hundreds channels. In the present invention, an inexpensive satellite broadcasting system has been already put into practical use in various fields and can be utilized without modification.

[Utilization of multi-media technique]

In the present invention, one feature is utilization of multi-information technique presented by using the latest signal processing technique.

A conventional conference system mainly uses a TV conference system using a moving picture. However, considering the essential of a conference, it is understood that a complete TV (TV conference system using the moving picture) is not necessary.

First of all, a voice of a speaker is necessary and essential for the conference system. In accordance with the progress of a voice encoding technique, a transmitting rate is approximately 20 kbps (kbit/sec) and this transmitting rate is sufficient for audio quality of the conference.

Secondarily to the voice of the speaker in the conference system, an image of the speaker and resources presented by the speaker are necessary, Ordinarily, a still image is sufficient to transmit this information. Although the moving picture and the voice with a high quality must be temporarily necessitated as needs arise, averagely, at least communication capacity of 64 kbps to 256 kbps is sufficient. Since the current TV uses a band of approximately 5 MHz, communication with a capacity corresponding to about 50 times can be performed by using the same band

[Combination of the Internet and satellite communication]

An image, photograph, and picture as well as a voice can be efficiently transmitted via an Internet communication network by using the above-described multimedia technique. This means effective implementation of communication from a subscriber (participant in the conference) to the conference center.

Internet communication in the opposite way of the above-description, namely, multicasting from the conference center to the subscriber (participant in the conference) is extremely infeasible.

In the present invention, the feature of the Internet is advantageously employed and the problems are compensated for by the satellite communication.

In the present invention, it is characterized to present conference contents to the subscriber having a satellite communication terminal capable of receiving a signal from the communication satellite on a broadcast system.

In the present invention, the satellite communication conference system has a conference center which is connected to a satellite earth station to transmit a broadcast signal to the communication satellite. The conference center comprises a back-way communicating function for receiving a voice request signal from the subscriber and a comment signal from the participant to whom a voice is given. A ground communication network is used as the back-way communicating function for the subscriber having the satellite communication terminal without a transmitting function to the communication satellite.

In order to present the back-way communicating function to a user having the satellite communication terminal with the transmitting function to the communication satellite, the satellite earth station comprises a satellite communicating function for receiving the above signal from the subscriber which is communicated via the communication satellite and a function for transferring the received signal to the conference center

The conference center comprises a communicating function with a chairperson to compere the conference in response to the above signal which is received via the back-way communication network using a ground line or satellite line. If the chairperson is absent, the conference center has a chairperson unit for controlling the proceedings of the conference Function of the chairperson unit is described hereinbelow.

Automatically broadcast notification of the opening of the conference

Receive an attendance noticing signal from the participant

Notify the acceptance of attendance of an attendant

Distribute a conference decipher key

Broadcast an attendance list

Broadcast a voice accepting state

Receive a voice request signal

Select the speaker and notify the permission of him/her

Broadcast a comment signal and control the end of comment

Broadcast the declaration of the end of the conference

Control disconnecting operation of a satellite line

The satellite communication conference system is available to the variety of applications such as educational or research seminar to which an enormous participants attend, call-in broadcast, local information system, political and economic discussion by broadcasting a broadcast signal to be generated by the chairperson unit via the satellite communication network

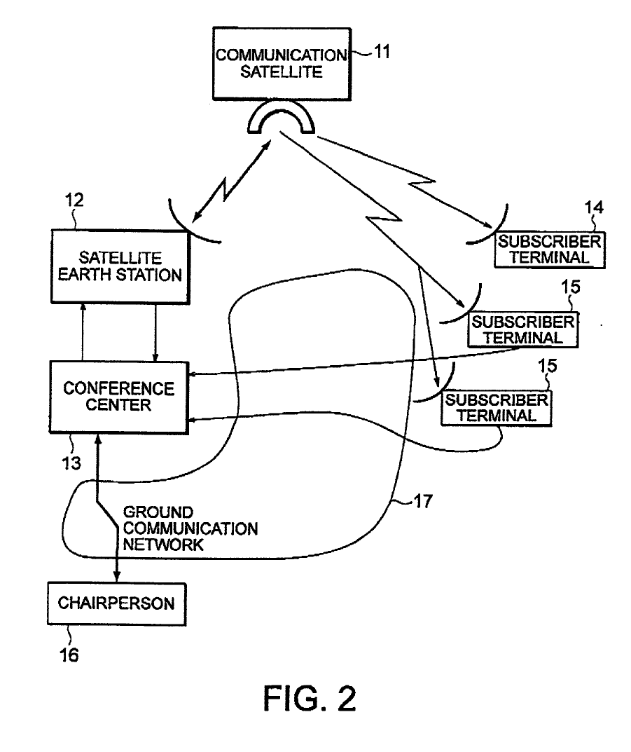

An embodiment of the present invention will be described with reference to FIGS. 2 to 5. FIG. 2 is a diagram showing the configuration of a satellite communication conference system according to the embodiment of the present invention. Referring to FIG. 2, the satellite communication conference of the present invention is carried out via a communication satellite 11. The satellite communication conference system includes a satellite earth station 12, a satellite communication conference center (hereinafter, abbreviated to a conference center) 18, subscriber terminals 14 and 15, and a chairperson 16 of the conference

The subscriber terminal 14 comprises a function for receiving a signal from the communication satellite 11 and a bidirectional satellite communicating function capable of transmitting data to the communication satellite 11. On the other hand, the subscriber terminal 16 is a reception-only terminal to the communication satellite 11 and, that is, it comprises a function for receiving a signal from the communication satellite 11 but no function for transmitting the signal to the communication satellite 11.

A ground communication network 17 is, for example, a telephone (mobile radio system or public telephone network), a facsimile, an Internet network, or the like.

A shown in FIG. 2, the conference center 13 satellite-communicates with all subscriber terminals 14 and 15 via the satellite earth station 12 and the communication satellite 11. The conference center 13 has a communicating function with the subscriber terminal 15 via a telephone and a facsimile, an e-mail, and the Internet by way of the ground communication network 17 and a communicating function with the chairperson 16 by way of the ground communication network 17 or communication satellite 11.

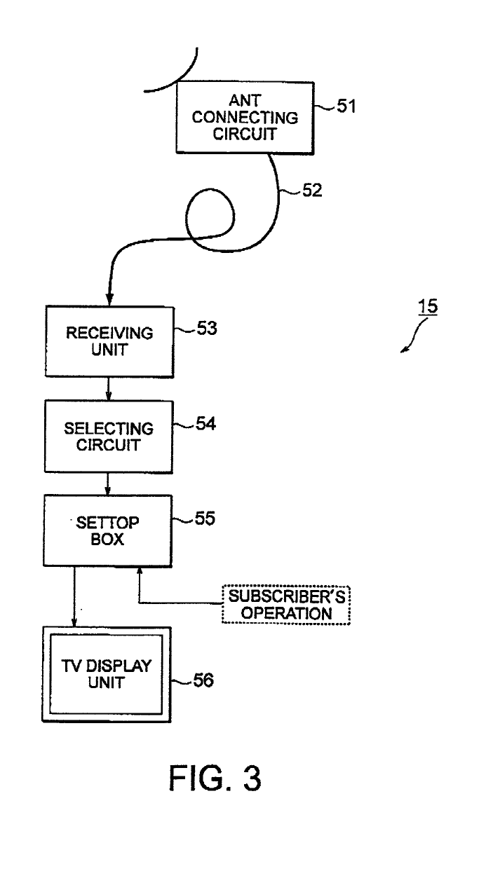

FIG. 3 is a diagram showing an example of the configuration of the subscriber terminal 15 that is the reception-only terminal. Referring to FIG. 3, the subscriber terminal 15 includes a satellite communication receiving antenna and connecting circuit (hereinafter, abbreviated to an ANT connecting circuit) 51, a connecting cable 52, a receiving unit 53 for amplifying and demodulating a reception signal, a selecting circuit 54 for selecting a signal addressed to a corresponding subscriber from the reception signals, a set top box (hereinafter, abbreviated to an STB) 55, and a TV display circuit 56 for displaying an image with an audio sound in response to the signal from the STB 55. The STB 55 stores selected signals and reproduces the image and the audio sound in accordance with subscriber's operation.

Currently, the configuration of the subscriber terminal 15 shown in FIG. 3 can be implemented by employing the direct satellite broadcast (DSB) which is used for business purpose without modification. In this case, generally, the ANT connecting circuit 51 is set outside and other components are set inside.

The STB 55 and the TV display circuit 56 can be operated as receiving display units of normal satellite broadcast in accordance with the subscriber's operation and can also be operated as terminals of the satellite communication conference in the conference system of the present invention.

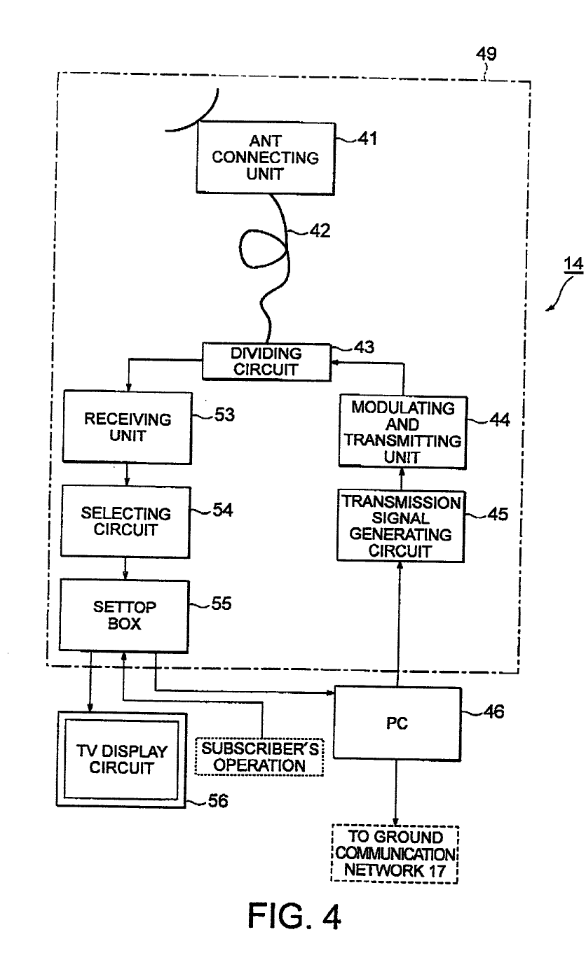

FIG. 4 is a diagram showing an example of the configuration of the subscriber terminal 14 having a receiving and transmitting function from/to the communication satellite 11. Referring to FIG. 4, the same reference numerals denote the same components shown in FIG. 3. The subscriber terminal 14 includes a satellite communication antenna and connecting circuit (hereinafter, abbreviated to an ANT connecting circuit) 41 capable of reception and transmission, a connecting cable 42, a dividing circuit 43 for dividing a reception signal and a transmission signal, and an information terminal 46 such as a personal computer (hereinafter, abbreviated to a PC). A signal produced by the PC 46 is generated on a predetermined transmission signal basis by a transmission signal generating circuit 45, is processed such as modulation, frequency setting, and amplification on a predetermined format by a modulating and transmitting unit 44, and is transmitted to the ANT connecting circuit 41.

Compare FIG. 4 with FIG. 3, obviously, a receiving unit of the subscriber terminal 14 can be shared with a receiving unit in the direct satellite broadcast, and a transmitting unit can also be shared with a terminal unit of the VSAT Very Small Aperture Terminal) system.

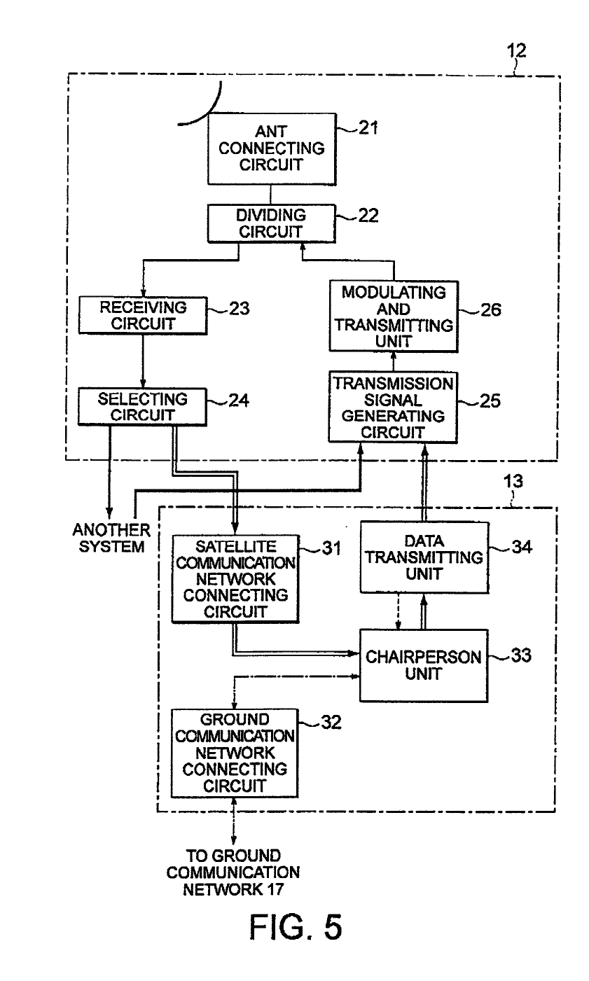

FIG. 5 is a diagram showing the configuration of the satellite earth station 12 and the conference center 13 according to the embodiment of the present invention. Referring to FIG. 5, the satellite earth station 12 includes an antenna and connecting circuit capable of reception and transmission (hereinbelow, abbreviated to an ANT connecting circuit) 21, a dividing circuit 22 for dividing a reception signal and a transmission signal, a receiving unit 23, a selecting circuit 24, a transmission signal generating circuit 25, and a modulating and transmitting unit 26.

The conference center 13 includes a satellite communication network connecting circuit 31 for receiving a signal from the satellite earth station 12, a ground communication connecting circuit 32 for connection of reception/transmission through a ground communication network such as a telephone, facsimile, or e-mail, a chairperson unit 33, and a data transmitting unit 34 for reading information from the chairperson unit 33, generating it on a broadcast format, and transmitting it to the satellite earth station 12. The chairperson unit 33 accepts a voice request signal which is issued from a participant in the conference through the communication satellite or ground communication network, determines the participant to whom a voice is granted, and generates a voice grant signal for broadcasting the above determination through the communication satellite. The chairperson unit 33 produces a comment broadcast signal for broadcasting the comment signal from the participant to whom the voice is granted via the communication satellite.

In the conference system of the present invention, the problems on both the Internet and the satellite conference system mentioned above can be solved. That is, the conference system of the present invention broadcasts comment contents by using the broadcast of the communication satellite and, accordingly, transfer efficiency is improved. The subscriber terminal can be shared with a receiving terminal in the direct satellite broadcast and, thus the apparatus becomes inexpensive. The request for voice is transmitted to the conference center 13 by using the Internet. The subscriber to whom the voice is granted can be connected to the conference center 13 via a voice Internet (VoIP) or telephone network and, therefore, existing communication equipment can be employed without modification. Consequently, costs of the system becomes inexpensive.

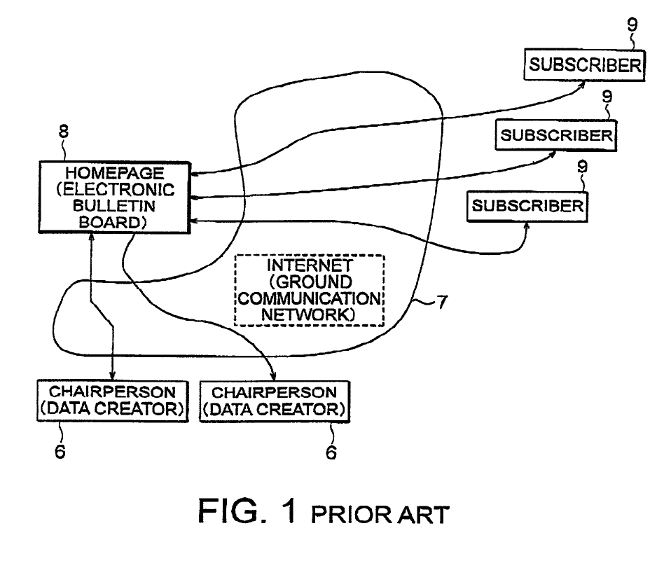

As stated above with reference to FIG. 1, in the conference system using the Internet, the chairperson 6 forms the agenda of conference and sets it on the electronic bulletin board of the homepage 8. One subscriber 9 accesses the homepage 8 via the Internet, reads out a predetermined agenda of the conference, and writes a comment if he/she desires to add the comment. The other subscriber 9 accesses the electronic bulletin board, reads the agenda of the conference and the comment of the participant, writes a comment if he/she desires to add the comment, thereby performing the conference based on a storage method. The chairperson 6 facilitates the discussion on the electronic bulletin board in the case of inputs from the subscribers 9. As mentioned above, the participant inputs the comment and reads out it at his convenient time.

According to the embodiment of the present invention, a description is given of the processing routine of the conference with reference to FIGS. 2 and 5 hereinbelow.

(1) As shown in FIG. 2, the chairperson 16 may be not necessarily in the conference center 13. So long as the chairperson 16 accesses the conference center 13 via the ground communication network 17, he/she can act as a chairperson.

(2) At a scheduled time, the chairperson 16 accesses the conference center 13 and declares the opening of the conference via the communication satellite 11.

(3) When the participant having the subscriber terminal 14 or 15 hears the declaration of the opening of the conference, he/she transmits the attendance notifying signal to the chairperson 16 via the Internet or communication satellite 11 by way of the conference center 13. The attendance notifying signal includes an ID of the participant and a unique cipher key.

(4) The chairperson unit 33 in the conference center 13 which receives the attendance reception signal forms a list of participants and transmits it to the chairperson 16. Simultaneously, the chairperson unit 33 distributes an acceptance confirming signal including a conference signal decipher key which is designated to each attendant and is ciphered by the cipher key via the ground communication network or satellite communication network in accordance with a route of the attendance notifying signal. Thereafter, the subscriber receives and deciphers a satellite broadcast signal by using the cipher key which is distributed by the acceptance confirming signal.

(5) The chairperson 16 broadcasts the list of participants via the communication satellite 11 as needs arise, declares the establishment of the conference, and starts the conference.

(6) The comment of the participant to whom the voice is granted in the conference is broadcasted via the chairperson unit 33 by way of the communication satellite 11 in the conference. Incidentally, the chairperson 16 always retains his/her voice and can broadcast his/her voice at any time as the need arises.

(7) The chairperson 16 sets a comment accepting state and broadcasts a comment accepting signal if he/she desires the participant's comment.

(8) When the comment accepting signal is received, the subscriber terminals 14 and 15 display the reception on the TV display circuit 56. In this case, the participant desiring the comment transmits a voice request signal to the conference center 13 via the ground communication network or satellite communication network The voice request signal includes an ID of the requesting participant.

(9) The chairperson 16 selects one of requesting participants, and transmits an instruction signal indicating the selected one to the conference center 13. The chairperson unit 33 forms a voice grant signal in accordance with the instruction signal, and broadcasts the voice grant signal via the communication satellite 11.

(10) The subscriber terminal 14 or 15 to which the voice is granted receives the voice grant signal from the communication satellite 11 and, then, displays the comment permitting state by, for example, a green lamp (or an LED of the terminal).

(11) The subscriber to which the comment permitting state is displayed transmits the comment signal to the conference center 13. The comment signal includes the ID of the subscriber to whom the comment is permitted.

(12) The chairperson unit 33 confirms that the reception signal is the comment signal from the subscriber to whom the voice is granted, then, forms the broadcast signal including the comment signal, and broadcasts the formed signal via the communication satellite 11.

(13) If pressing an end button in the terminal of the speaker, the chairperson unit 33 detects a comment end signal. If the chairperson unit 33 detects the comment end signal, the processing routine shifts to the comment accepting state. Alternatively, the chairperson 16 can forcedly end the comment. The chairperson unit 33 broadcasts the comment accepting signal in the comment accepting state.

(14) The conference progresses by repeating the above operation.

(15) The chairperson 16 exercises a chairperson voice at the scheduled time of the end of conference, declares the close of the conference, and broadcasts the declaration via the communication satellite 11. The chairperson unit 33 disconnects the satellite line.

Although the above embodiment exemplifies the operation when the chairperson 16 is present, the chairperson 16 is not always necessary. If the chairperson 16 is absent, the chairperson unit 33 performs the functions of the chairperson 16. Accordingly, the conference can be realized as follows.

(A) The chairperson unit 33 automatically broadcasts an opening declaring signal at the scheduled time.

(B) If tie opening declaring signal is received, the attendance notifying signal is transmitted to the chairperson unit 33 from the subscriber terminals 14 and 15 in the same manner as that of the above description.

(C) The chairperson unit 33 distributes the conference signal decipher key to each participant whose attendance is notified in the same manner as that of the above description.

(D) The chairperson unit 33 broadcasts the list of participants by way of the communication satellite 11 in the above-stated manner.

(E) The chairperson unit 33 broadcasts the comment accepting signal indicating the comment accepting state and waits for the voice request signal from the participant

(F) If the voice request signal is accepted, the chairperson unit 33 selects one of the participants in accordance with a predetermined method and broadcasts the voice grant signal in the same manner as that of the above description. Considerable predetermined methods are, for example, a method in order of arrival, a method for weighting priorities of the subscribers, etc. Likewise, the comment signal of the participant to whom the voice is granted is broadcasted via the communication satellite 11.

(G) The return of voice is notified to the chairperson unit 33 by transmitting a return signal by the speaker at the end of comment.

(G′) Alternatively, if a predetermined comment restricting time passes, the chairperson unit 33 forcedly deprives the voice, thereby entering the comment accepting state Then, such a fact is broadcasted in the above-described manner.

(H) The operation (F) to (G′) is iterated and the conference progresses.

(I) If a predetermined conference time passes, the chairperson unit 33 broadcasts the close declaring signal in the above-described manner and disconnects the satellite line.

In the subscriber terminal 14 shown in FIG. 4, a portion 49 surrounded by a dashed line can be integrally constituted. In a stationary satellite system having 200 or more spot beams which has already appeared, fast communication can be performed at several Mb/s by using a portable-type satellite communication terminal having the size of a laptop personal computer.

As mentioned above, the present invention can be embodied by the use of not only the existing satellite broadcast receiving unit, VSAT, or the like, but also the portable terminal in accordance with the future technical development.

The present invention has the following advantages.

A first advantage of the present invention is to realize a real-time conference system with the simple configuration at any place in the wide area at any time. Because the conference can be opened easily with low costs by using the exiting receiving unit in the direct satellite broadcast and by transmitting the voice request signal and comment signal from the participant via the existing ground communication network without modification.

A second advantage of the present invention is to realize a conference having the largest scale in the current conference systems. Because the wide area and broadcasting of the satellite communication eliminates the restriction for the number of participants.

A third advantage of the present invention is application to the vanity of fields such as an educational seminar, local information system, and call-in broadcast as well as the conference.

A fourth advantage of the present invention is that the application of multimedia technique enables the presentation of the number of conference channels several tens times that of the conventional TV channels by using a band thereof. As a consequence, it is applicable to the variety of fields such as call-in broadcast, education, academic conference, local information network, and political and economic discussion, and it is highly practicable.

What is claimed is:

1. A satellite communication conference system using satellite communication, wherein
a content of a comment of a speaker participating in a conference is broadcasted, via a communication satellite, to a plurality of conference participants each having a satellite communication terminal including receiving means for receiving a signal from said communication satellite

2. A satellite communication conference system according to claim 1, comprising
a conference center which is connected to a satellite earth station for communication with said communication satellite, wherein
said conference center comprises back-way communicating means for accepting a voice request signal from the conference participant and a comment signal from the participant to whom a voice is granted, and
said content of the comment of the speaker is transmitted to said communication satellite via said back-way communicating means and said satellite earth station.

3. A satellite communication conference system according to claim 2, wherein
said conference center further comprises communicating means for communication through a ground communication network as said back-way communicating means for the participant having the satellite communication terminal including no transmitting means to said communication satellite.

4. A satellite communication conference system according to claim 2, wherein
said satellite earth station comprises, as said back-way communicating means for the participant having the satellite communication terminal including transmitting means to said communication satellite,
satellite communicating means for receiving the voice request signal communicated via said communication satellite from the participant and the comment signal from the participant to whom the voice is granted; and
means for transferring the signal received by said satellite communicating means to said conference center

5. A satellite communication conference system according to claim 4, wherein
said conference center receives said voice request signal via said back-way communicating means using said ground communication network or said communication satellite, and said voice request signal includes identification information of the participant requesting the voice.

6. A satellite communication conference system according to claim 2, wherein
said conference center further comprises:
chairperson means for determining the participant, as a speaker, to whom the voice is to be granted in response to said voice request signal from the participant; and
means for broadcasting a voice grant signal via said communication satellite based on identification information of the participant to whom said voice is to be granted.

7. A satellite communication conference system according to claim 6, wherein
the terminal of the participant to whom said voice is granted comprises means for transmitting the comment signal to said conference center via said communication satellite or said ground communication network based on a predetermined, signal format, and
said conference center further comprises:
means for receiving said comment signal which is transmitted from the terminal of the participant to whom said voice is granted; and
means for controlling operation to transmit said received content of the comment to said satellite earth station and to broadcast the transmitted content via said communication satellite.

8. A satellite communication conference system according to claim 6, wherein
said chairperson means comprises means for controlling operation to broadcast a comment accepting signal via said communication satellite in a comment accepting state, and for accepting a request for the comment only in the comment accepting state.

9. A satellite communication conference system according to claim 6, wherein
said chairperson means controls operation to accept a request for the comment and to grant the voice by predetermined operation based on chairperson's determination.

10. A satellite communication satellite system according to claim 8, wherein
said chairperson means further comprises means for automatically controlling operation to accept the request for the comment and to grant the voice.

11. A satellite communication conference system according to claim 10, wherein
said chairperson means selectively controls operation to grant the voice in order of arrival, or operation to set a comment time duration to a predetermined time duration, to automatically deprive the voice when said predetermined time duration passes, to shift a state to the comment accepting state, and to accept a new request for the comment.

12. A satellite communication conference system according to claim 2, wherein
said conference center further comprises means for accepting an attendance notifying signal from the participant in the conference via said back-way communicating means prior to opening of the conference and for returning an acceptance confirming signal to said accepted participant in the conference.

13. A satellite communication conference system according to claim 12, wherein
said conference center further comprises means for distributing a decipher key used for said conference to all of said participants in the operation to accept the attendance notifying signal of said participant in the conference and in the operation to return the acceptance confirming signal.

14. A satellite communication conference system carrying out conference via a communication satellite and comprising;
a receiving and transmitting terminal having a receiving and transmitting function to said communication satellite;
a receiving terminal having only a receiving function to said communication satellite;
a satellite earth station for communication via said communication satellite; and
a conference center connected to said satellite earth station;
said conference center and said receiving and transmitting terminal being capable of connecting via a satellite communication network, said conference center and said receiving terminal being capable of connecting via a ground communication network;
a content of a comment of a speaker participating in the conference being broadcasted, via said communication satellite, to a participant having said receiving and transmitting terminal and to a participant having said receiving terminal; and
said conference center comprising means for receiving a voice request signal from said participant and a comment signal from the participant to whom a voice is granted via said ground communication network for the participant having said receiving terminal.

15. A satellite communication conference system according to claim 14, wherein
said earth communication network includes at least one of Internet communication, telephone network, and facsimile communication.

16. A satellite communication conference method using satellite communication, comprising the step of
broadcasting a content of a comment of a speaker participating in a conference, via a communication satellite, to a plurality of participants in the conference having terminals including a function for receiving a signal from said communication satellite.

17. A satellite communication conference method according to claim 16, further comprising the steps of:
connecting a conference center to a satellite earth station for communication with said communication satellite; and
accepting a request for the comment and the content of the comment by using a ground communication network by said conference center for the participant having a receiving terminal including only a receiving function to said communication satellite.

18. A satellite communication conference method, as a business model, for presenting a satellite communicating service ill a satellite communicating conference system which comprises a receiving and transmitting terminal including a receiving and transmitting function to a communication satellite, a receiving terminal including only a receiving function to said communication satellite, a satellite earth station for communication via said communication satellite, a conference center connected to said satellite earth station, a satellite communication network for connecting said conference center and said receiving and transmitting terminal, and a ground communication network for connecting said conference center and said receiving terminal, wherein
a content of a comment of a speaker participating in the conference is broadcasted, via said communication satellite, to a participant having said receiving and transmitting terminal and to a participant having said receiving terminal, and
said conference center comprises means for receiving a voice request signal of said participant and a comment signal from the participant to whom a voice is granted via said ground communication network for the participant having said receiving terminal.

19. A satellite communication conference system according to claim 18, further comprising the steps of:
(1) declaring opening of the conference at the start of the conference via said communication satellite by a chairperson in said conference center or by a chairperson connected to said conference center via said ground communication network;
(2) receiving declaration for said opening of the conference and transmitting an attendance notifying signal to said chairperson via said conference center by way of said ground communication network or said satellite communication network by the participant having the terminal including the receiving and receiving function to said communication satellite or the terminal comprising only the receiving function to said communication satellite;
(3) forming a list of the participant in the conference, transmitting the formed list to said chairperson, and distributing an acceptance confirming signal including a conference decipher key ciphered by a cipher key designated to each participant in the conference via said ground communication network or via said satellite communication network in accordance with a route of said attendance notifying signal by a chairperson unit in raid conference center, and,
thereafter, receiving and deciphering a satellite broadcast signal by using the cipher key, which is distributed by said acceptance confirming signal, by the terminal of the participant;
(4) broadcasting said list of the participants in the conference via said communication satellite as needs arise, declaring establishment of the conference, and starting the conference by said chairperson; and
(5) broadcasting the comment of the participant to whom the voice is granted via said chairperson unit by way of said communication satellite.

20. A satellite communication conference method according to claim 19, further comprising the steps of:
(6) setting a comment accepting state when the comment is obtained from the participant, and broadcasting a comment accepting signal by said chairperson;
(7) when said comment accepting signal is received, displaying such a fact on said terminal of the participant, and transmitting the voice request signal to said conference center via said ground communication network or via said satellite communication network by the participant desiring to add the comment;
(8) selecting one of the participants requesting the comment by said chairperson, and forming the voice grant signal and broadcasting the formed signal via said communication satellite by said chairperson unit;
(9) displaying a comment permitting state by the terminal of the participant to whom the voice is granted when the voice grant signal is received from said communication satellite;
(10) transmitting the comment signal to said conference center by the participant of the terminal on which said comment permitting state is displayed;
(11) confirming the signal from the participant to whom the voice is granted, thereafter, forming a broadcast signal including said comment signal, and broadcasting the formed broadcast signal via said communication satellite by said chairperson unit;
(12) when end of the comment is inputted by said terminal of the speaker, detecting a comment end signal by said chairperson unit and shifting to the comment accepting state, or forcedly ending the comment by said chairperson to enter in the comment accepting state and broadcasting the comment accepting signal by said chairperson unit; and
(13) declaring close of the conference at end of the conference, broadcasting the declaration via said communication satellite by said chairperson, and disconnecting a satellite line by said chairperson unit.

21. A satellite communication conference method according to claim 18, further comprising the steps of:
(A) automatically broadcasting an opening declaring signal via said communication satellite at scheduled time of start of the conference by said chairperson unit in the conference center;
(B) when said opening declaring signal is received, transmitting an attendance notifying signal to said chairperson unit from the terminal including the receiving and transmitting function to said communication satellite or the terminal including only the receiving function to said communication satellite;
(C) forming a list of the participant in the conference and distributing an acceptance confirming signal including a conference decipher key ciphered by a cipher key designated to each participant in the conference via said ground communication network or said satellite communication network in accordance with a route of said attendance notifying signal by said chairperson unit in said conference center, and,
thereafter, receiving and deciphering a satellite broadcast signal by using the cipher key distributed by said acceptance confirming signal by said terminal of the participant in the conference;
(D) broadcasting said list of the participants in the conference via said communication satellite as needs arise, declaring establishment of the conference, and starting the conference by said chairperson unit;
(E) broadcasting a notifying signal in the comment accepting state and waiting for the voice request signal from the participant by said chairperson unit;
(F) selecting one of the participants requesting the comment based on a predetermined format when said voice request signal is received, and broadcasting the voice grant signal by said chairperson unit;
(G) broadcasting the comment signal of the participant to whom the voice is granted via said communication satellite;
H) notifying said chairperson unit of return of the voice by broadcasting a return signal at the end of comment by the speaker, or forcedly depriving the voice, entering to the comment accepting state, and broadcasting the comment accepting state by said chairperson unit if a predetermined comment restricting time duration passes and
(I) broadcasting close of the conference by a close declaring signal if a predetermined conference time duration passes and disconnecting the satellite line by said chairperson unit.
